(19) United States
(12) Patent Application Publication
(10) Pub. No.: US 2013/0032375 A1
(43) Pub. Date: Feb. 7, 2013

(54) BROMINATED EPOXY FLAME RETARDANT PLASTICIZER

(71) Applicants: Pierre Georlette, Omer (IL); Paul Y. Moy, Fishkill, NY (US)

(72) Inventors: Pierre Georlette, Omer (IL); Paul Y. Moy, Fishkill, NY (US)

(73) Assignee: ICL-IP America Inc., Ardsley, NY (US)

(21) Appl. No.: 13/344,218

(22) Filed: Jan. 5, 2012

Related U.S. Application Data
(60) Provisional application No. 61/432,360, filed on Jan. 13, 2011.

(51) Int. Cl. H01B 7/295

(52) U.S. Cl. 174/110 SR

(57) ABSTRACT

There is provided, herein a wire and/or cable comprising (a) a conductor and (b) a covering comprising a brominated epoxy oligomer; and, a phosphate ester.

### FIELD OF THE INVENTION

The present invention relates to a wire or cable comprising a brominated compound. More specifically, there is provided a wire or cable composition comprising a brominated oligomer which provides advantageous flame retardancy and low smoke propagation.

### BACKGROUND OF THE INVENTION

Plenum grade wire arid cable demands a high level of flame retardancy

and low smoke propagation. To facilitate installation, wire and cable products are threaded through the ductwork of high-rise buildings. However, in the event of a fire, the insulation and jacketing material of these wire and cable products can be a fuel source if not adequately flame retarded mid can quickly spread, fire and smoke to other areas of the building.

To that end, wire and cable products are held to very stringent flammability and smoke standards. To achieve these high standards, proper formulations must be designed to afford both a high degree of flame resistance coupled with a low propensity for evolving smoke while maintaining good permanence and flexibility throughout its service life. Current technology for flexible FR-PVC uses a combination of flame retardant materials including phosphate esters, organobromo compounds (typically brominated phthalate esters) and various inorganic products. But there continues to be a demand in the field for improvements in the flame retardancy and smoke propagation properties in wire and cable applications which are desired in order to meet more stringent desires and/or standards.

### SUMMARY OF THE INVENTION

This invention discusses the unexpected discovery of enhanced flammability and stability, as well as desirable levels of smoke propagation in wire and cable applications through the use of a brominated epoxy oligomer (BEO). More specifically, it has been unexpectedly found by the inventors herein, that by substituting known brominated compounds such as brominated phthalate esters used in wire and cable coating materials, with a BEO, that there was an enhanced stability, as well as an unexpected improvement in flammability, while maintaining suitably low smoke propagation properties. This improvement is accomplished by the use of BEO instead of a brominated phthalate ester (DP45, Chemtura) having an equivalent bromine level.

The present invention relates to a wire and/or cable comprising (a) a conductor and (b) a covering comprising;

(i) a brominated epoxy oligomer: and,

(ii) a phosphate ester.

### BRIEF DESCRIPTION OF THE DRAWING

FIG. 1 is a graph of the Heat Release Rate of vinyl composites containing various brominated epoxy oligomers.

### DETAILED DESCRIPTION OF THE INVENTION

In accordance with the present invention, it has unexpectedly been found that the use of BEO in wire and/or cable applications, such as in the coating of a wire and/or cable products results in improved flame retardancy and stability, with suitable smoke propagation properties as compared to brominated phthalate ester compounds previously used.

The brominated epoxy oligomer herein can comprise any brominated compound containing at least one epoxy group and/or at least one ring-opened epoxy group. The brominated epoxy oligomer will preferably contain brominated phenyl groups, more preferably wherein the phenyl groups contain at least two bromine moieties.

The BEO can be any brominated compound containing epoxy moiety, for example, monofunctional epoxies, aliphatic, cycloaliphatic, and aromatic monofunctional epoxy resins and includes such chemistries as cresyl glycidyl ether, benzyl glycidyl ether, provided such compounds contain bromine moieties. Other useful epoxy resins of the present invention include, but are not limited, to difunctional, trifunctional, tetrafunctional, and higher functional epoxy resins, provided they contain at least one bromine moiety. Examples of these types of epoxies include, but are not limited to diglycidyl ethers of bisphenol A, diglycidyl ethers of bisphenol F, diglycidyl ether of bisphenol S, diglycidyl-p-aminophenol, triglycidyl aminocresol, triglycidyl-p-aminophenol, tetraglycidyl ethers of methylenedianiline, phenol novolac type epoxy resins, cresol novolac type epoxy resins, resorcinol type epoxy resins, epoxy resins with a naphthalene skeleton, biphenyl type epoxy resins, dicyclopentadiene type epoxy resins and diphenylfluorene type epoxy resins, and the like, provided they each contain at least one bromine moiety. These resins can be used individually or in any appropriate combinations. Any compatible mixtures of any of these resins may be employed, if desired.

In one embodiment the BEO contains at least one repeat unit, preferably 1 to 10, more preferably 1 to 6, even more preferably 1 to 3 repeat units of the general formula:

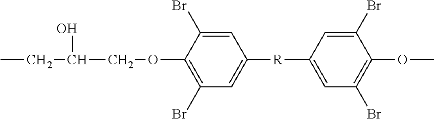

where R is a divalent alkylene group containing from 1 to about 6 carbon atoms, preferably from 1 to 3 carbon atoms such as the non-limiting examples of methylene, ethylene, propylene and isopropylene.

In one embodiment herein the brominated epoxy oligomer contains at least one repeat unit, preferably 1 to 10, more preferably 1 to 6, even more preferably 1 to 3 repeat units of the general formula:

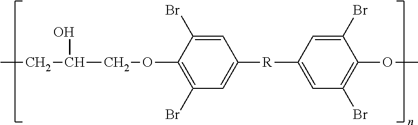

In one other embodiment herein the BEO is selected from the group consisting of

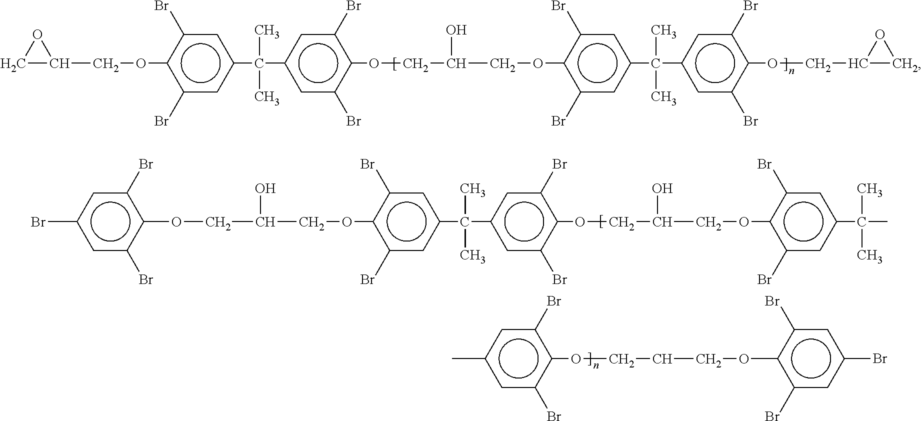

and combinations thereof wherein n is 0 or from about 1 to about 10, preferably from 1 to about 6, and most preferably 1 to about 3.

The phosphate ester employed herein can be a monomeric phosphate ester or an oligomeric phosphate ester, each of which can be halogenated or non-halogenated.

A preferred class of monomeric phosphate esters are of the formula O═P—(OR¹)₃ wherein R¹ is independently selected from alkyl, alkoxyalkyl and haloalkyl containing up to about 8 carbon atoms. In one embodiment substitutents can be halogenated, e.g., chloroalkyl containing from 1 to 4 carbon atoms. Representative compounds of this type that can be used herein with generally good results include tris(chloroethyl)phosphate (TCEP), tris(chloropropyl)phosphate (TCPP), tris(dichloroisopropyl)phosphate (TDCP) and 2,2-bis(chloromethyl)trimethylene bis[bis(2-chloroethyl)phosphate] (chlorinated diphosphate or V6 type product) and their mixtures. Mixtures of different phosphate ester compounds are also contemplated, e.g., mixtures of halogenated and non-halogenated phosphate esters.

The phosphate ester herein can have the following general formula:

(R²O)ₙP(O)(OR³)₃₋ₙ.

wherein n is equal to 1 or 2, R² is an alkyl group of from 1 to about 30 carbon atoms, preferably from 1 to about 21 carbon atoms, preferably 1 to about 12 carbon atoms, and R³ is an aryl group having up to about 14 carbon atoms, preferably up to 10 carbon atoms, more preferably up to 12 carbon atoms. In one aspect of the present invention, the flame-retardant phosphate esters have the general formula (R²O)ₙP(O)(OR³)₃₋ₙ, wherein n is equal to 0, 1, or 2. R² is an alkyl group containing from about 1 to about 6 carbon atoms, and R³ is a phenyl group.

In one embodiment of the present invention, the phosphate ester includes, diethyl phenyl phosphate, ethyl diphenyl phosphate, di-n-propyl phenyl phosphate, n-propyl diphenyl phosphate, di-n-butyl phenyl phosphate, n-butyl diphenyl phosphate, di-isobutyl phenyl phosphate, isobutyl diphenyl phosphate, di-n-pentyl phenyl phosphate, n-pentyl diphenyl phosphate, di-n-hexyl phenyl phosphate, n-hexyl diphenyl phosphate, and mixtures thereof.

The phosphate ester component can also be of the oligomeric type, e.g., a phosphate ester oligomer having a phosphorus content of not less than about 5%, and preferably not less than 10%, by weight.

The phosphate esters of the present invention can be used alone or in combinations thereof. For economic and production reasons the alkyl phenyl phosphate esters of the present invention are often used as mixtures without significantly affecting product performance.

In one embodiment the phosphate ester can be any phosphate ester than contains at least one aryl moiety, wherein the aryl moiety can be alkyl substituted or non-substituted. When the aryl moiety is alkyl substituted it can comprise substitution by an alkyl of from 1 to 6 carbon atoms, preferably from 1 to 4 carbon atoms, most preferably, methyl, ethyl, propyl, isopropyl, butyl, isobutyl, tert-butyl and the like, wherein such alkyl substitution can occur in any one or more of the available carbon atoms of the aryl moiety.

In another embodiment herein, the aryl phosphate ester is of the general formula

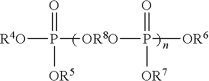

wherein n is 0 or 1 to about 10, R⁴, R⁵, R⁶ and R⁷ each independently is a non-halogenated or halogenated alkyl or aryl group containing up to about 30 carbon atoms, preferably up to about 25 carbon atoms, more preferably up to about 21 carbon atoms, even more preferably up to about 12 carbon atoms, and R⁸ is a non-halogenated or halogenated alkylene or arylene group, provided, that, at least one of R⁴, R⁵, R⁶, R⁷ and R⁸ is aryl of 6-20 carbon atoms, preferably phenyl; and, provided when n is 0, then at least one of R⁴, R⁵, R⁶ and R⁷ is aryl of 6-20 carbon atoms, preferably phenyl. It will be understood herein that when any of R⁴, R⁵, R⁶, R⁷ and R⁸ is an aryl group, such aryl group can be unsubstituted or can be alkyl substituted with at least one linear or branched alkyl group having up to 9 carbon atoms, preferably up to 6 carbon atoms, most preferably up to 4 carbon atoms, such as the non-limiting examples of methyl ethyl, n-propyl, n-butyl, n-pentyl, n-hexyl, iso-propyl, iso-butyl, sec-butyl, tart-butyl, iso-pentyl, tert-pentyl, neo-pentyl, iso-hexyl, and the like. It will be understood herein that such alkyl substitution can occur on any available carbon atom of the aryl group. In one non-limiting embodiment the aryl group is phenyl and alkyl substitution can occur on up to 5 of the carbon atoms on the aryl group, preferably up to 3 carbon atoms on the aryl group, most preferably one carbon atom on the aryl group.

Examples of R⁴, R⁵, R⁶ and R⁷ include linear alkyl groups of from 1 to 6 carbon atoms such as methyl, ethyl, n-propyl, n-butyl, n-pentyl, n-hexyl, and branched alkyl groups of from 3 to 7 carbon atoms such as iso-propyl, iso-butyl, sec-butyl, tert-butyl, iso-pentyl, tert-pentyl, neo-pentyl, iso-hexyl, and the like. In one embodiment herein, R⁴, R⁵, R⁶ and R⁷ are linear alkyl groups having from 1 to 9 carbon atoms, preferably from 1 to 6 carbon atoms, even more preferably from 2 to 6 carbon atoms, with R¹ being ethyl and R² being butyl being most preferred.

In one embodiment, the aryl phosphate ester is selected from the group consisting of butylated aryl phosphate, a propylated aryl phosphate, or a methylated aryl phosphate. In one embodiment such a butylated aryl phosphate could be t-butyl substituted. In one other embodiment such a propylated aryl phosphate could be isopropyl-substituted.

In one more specific embodiment, the aryl phosphate ester is selected from the group consisting of dibutyl phenyl phosphate, butyl diphenyl phosphate, 2-ethylhexyl diphenyl phosphate, isodecyl diphenyl phosphate, cresyl diphenyl phosphate, triphenyl phosphate, tricresyl phosphate, butylated or isopropylated triphenyl phosphate and combinations thereof.

In one specific embodiment the aryl phosphate ester herein is available as Phosflex 71B from ICL Supresta Inc.

In one most specific embodiment herein the phosphate ester is selected from the group consisting of isodecyl diphenyl phosphate ester, such as Phosflex 390 available from ICL Supresta; isopropylated triphenyl phosphate ester, such as Phosflex 31L, available from ICL Supresta; and, C12-C14 linear ester of diphenyl phosphate, such as Santicizer 2148 available from the Ferro Corporation.

Additionally, the covering may optionally also contain various additives, such as polymeric binders (such as the non-limiting examples of vinyl resins, such as poly(vinyl chloride) resin, and the like), viscosity-modifying agents, surfactants, chain-extending agent, antioxidants; fillers and reinforcing agents such as, for example, silicates, TiO₂, fibers, glass fibers, glass spheres, calcium carbonate, talc, and mica; mold release agents; UV absorbers; stabilizers such as light stabilizers and others; lubricants; plasticizers; pigments; dyes; colorants; anti-static agents; foaming agents; blowing agents; metal deactivators, and combinations comprising one or more of the foregoing additives.

The ratio of weight, percents herein of polymeric halogenated BEO to phosphate ester can vary greatly depending on the wire and/or cable application, the conductor, any insulator, and the like and can be in any ratio that provides for flame retardancy of at least 26.5, preferably at least 27, more preferably at least 27.5, and most preferably at least 28 LOI for 1.6 mm sample tested under ASTM test method D2863, and/or flame retardancy rating of V-0 for a sample of 1.6 mm; and/or an after flame time of less than 1.1 seconds, more preferably less than 1.0 seconds, even more preferably less than about 0.9 seconds and most preferably less than about 0.8 seconds as determined by the method used below for the values determined in Table 2; and smoke suppression of less than about 1700 l/s, preferably less than about 1600 l/s and most preferably less than about 1560 l/s as determined by cone calorimetry smoke analysis as explained below. These values of smoke suppression can in one embodiment have corresponding endpoints for the expression “less than” of at least 1 l/s, or any of 1,000; 1,100; or, 1,200. In another embodiment the ratio of weight percents herein of polymeric halogenated BEO to phosphate ester can be in any ratio that provides for average heat release rate of from less than about 250 kW/m², preferably less than about 240 kW/m² and most preferably less than about 225 kW/m².

In one embodiment, the ratio of polymeric halogenated BEO to phosphate ester can be present in any ratio that provides for a bromine content in the covering from about 1.0 to about 10.0%, preferably from about 6.0 to about 8.5% bromine. In a specific embodiment the ratio of polymeric halogenated BEO to phosphate ester can range from about 1:1 to about 1:3, preferably from about 1:1.2 to about 1:2.8, and most preferably from about 1:1.5 to about 1:2.5.

The method for making an electrical wire and/or cable can comprises melt mixing (compounding) the components used to form the covering, typically in a melt mixing device such as an compounding extruder or Banbury mixer. One or more melt mixing devices including one or more types of melt mixing devices can be used in these processes. In one embodiment, some components of the components that form the covering may be introduced and melt mixed, in an extruder used to coat the conductor. After some or all the components are melt mixed, the molten mixture can be melt filtered through one of more filters having openings. Any suitable melt filtration system or device that can remove particulate impurities from the molten mixture may be used. In one embodiment the melt is filtered through a single melt, filtration system. Multiple melt filtration systems are also contemplated.

In one embodiment the melt filtered mixture is passed through a die head and pelletized by either strand pelletization or underwater pelletization. The pelletized material may be packaged, stored and transported. In one embodiment the pellets are packaged into metal foil lined plastic bags, typically polypropylene bags, or metal foil lined paper bags. Substantially all of the air can be evacuated from the pellet filled bags.

In one embodiment the pellets are melted and the composition applied to the conductor by a suitable method, such as extrusion coating to form an electrical wire. For example, a coating extruder equipped with a screw, crosshead, breaker plate, distributor, nipple, and die can be used. The melted thermoplastic composition forms a covering disposed over a circumference of the conductor. Extrusion coating may employ a single taper die, a double taper die, other appropriate die or combination of dies to position the conductor centrally and avoid die lip build up.

In one embodiment, the composition is applied to the conductor to form a covering disposed over the conductor. Additional layers may be applied to the covering.

In one embodiment the composition is applied to a conductor having one or more intervening layers between the conductor and the covering to form a covering disposed over the conductor. For instance, an optional adhesion promoting layer may be disposed between the conductor and covering. In another example the conductor may be coated with a metal deactivator prior to applying the covering. In another example the intervening layer comprises a thermoplastic or thermoset composition that, in some cases, is foamed.

In one embodiment the conductor can be any conductor conventionally and/or commercially used for wire and/or cable applications, either metal or non-metal.

The conductor may comprise a single strand or a plurality of strands. In some cases, a plurality of strands may be bundled, twisted, or braided to form a conductor. Additionally, the conductor may have various shapes such as round or oblong. The conductor may be any type of conductor used to transmit a signal. Exemplary signals include optical, electrical, and electromagnetic. Glass fibers are one example of an optical conductor. Suitable electrical conductors include, but are not limited to, copper, aluminum, lead, and alloys comprising one or more of the foregoing metals. The conductor may also be an electrically conductive ink or paste.

The cross-sectional area of the conductor and thickness of the covering may vary and is typically determined by the end use of the electrical wire. The electrical wire can be used as electric wire without limitation, including, for example, for harness wire for automobiles, wire for household electrical appliances, wire for electric power, wire for instruments, wire for information communication, wire for electric cars, as well as ships, airplanes, and the like. In one embodiment the covered conductor is an optical cable and can be used in interior applications (inside a building), exterior applications (outside a building) or both interior and exterior applications. Exemplary applications include data transmission networks and voice transmission networks such as local area networks (LAN) and telephone networks.

In one embodiment the covering can comprise a coating on the conductor such as a coating of less than about 1.6 mm, e.g., from about 0.1 mm to about 1.6 mm in thickness, preferably from about 0.2 mm to about 1.2 mm and most preferably from about 0.3 mm to about 1.1 mm.

In one embodiment, during extrusion coating, the thermoplastic composition is melt filtered, prior to formation of the covering, through one or more filters having openings with a maximum diameter that is less than or equal to half of the thickness of the covering that will be applied to the conductor. For example, if the electrical wire has a covering with a thickness of 200 micrometers, the filter openings have a maximum diameter less than or equal to 100 micrometers.

In another embodiment the melt filtered mixture produced by melt mixing is not pelletized. Rather the molten melt filtered mixture is formed directly into a covering for the conductor using a coating extruder that is in tandem with the melt mixing apparatus, typically a compounding extruder. The coating extruder may comprise one or more filters as described above.

A color concentrate or masterbatch may be added to covering formulation prior to or during the extrusion coating. When a color concentrate is used it is typically present in an amount less than or equal to 3 weight percent, based on the total weight of the covering formulation. In one embodiment dye and/or pigment employed in the color concentrate is free of chlorine, bromine, and fluorine. As appreciated by one of skill in the art, the color of the covering prior to the addition of color concentrate may impact the final color achieved and in some cases it may be advantageous to employ a bleaching agent and/or color stabilization agents. Bleaching agents and color stabilization agents are known in the art and are commercially available.

After extrusion coating the electrical wire is usually cooled using a water bath, water spray, air jets, or a combination comprising one or more of the foregoing cooling methods. Exemplary water bath temperatures are 20 to 85° C. The water may be de-ionized and may also be filtered to remove impurities.

The following examples are offered to illustrate the general nature of the invention. Those skilled in the art will appreciate that they are not limiting to the scope and spirit of the invention and various and obvious modifications will occur to those skilled in the art. All parts are by weight unless otherwise stated.

### EXAMPLES

### Thermal/Process Stability

To examine the relative stability of these compounds, the formulations detailed in Table 1 (each component is expressed in parts by weight therein) were processed in a Brabender bowl mixer preset to an aggressive processing regime. These formulations were mixed at 180° C./55 rpm and once the components were fully dropped into the bowl, small samples (roughly one inch in diameter at ˜1.5 mm thickness) were extracted at identical prescribed time intervals. The times for the extraction were one (1), three (3), five (5), seven (7), nine (9), eleven (11), thirteen (13) and fifteen (15) minutes. A small hand tool was used to shape the molten vinyl into this disk form. This allowed the evolved color degradation of the compound to be “frozen” in the disk form. The sample disks of each formulation were visually compared for relative color development against the controls and noted if the maximum stability of these composites were exceeded (“end point” realized when the composite mixture cross-linked and the color transformed significantly to a dark brown or black residue indicating complete resin degradation).

The BEO flame retardants evaluated were;
F-2016 which is a brominated epoxy oligomer available from ICL-IP
F-2400 which is a brominated epoxy oligomer available from ICL-IP
F-3020 which is a brominated epoxy oligomer available from ICL-IP
F-3100 which is a brominated epoxy oligomer available from ICL-IP

Control brominated flame retardants for comparison were;
DP-45 which is a 2-ethylhexyl ester of tetrabromophthalate (BrDOP) available from Chemtura,
DBDPO (FR1208), which is a brominated flame retardant (decabromodiphenyl ether) available from ICL-IP.
   The following coating samples were used:

TABLE 1

| 1026-95 nb | 1 | 2 | 3 | 5 | 6 | 7 | 8 |
|---|---|---|---|---|---|---|---|
| Brominated FR | None | DP-45 | DBDPO | 2016 | 2400 | 3020 | 3100 |
| Type | | | | | | | |
| PVC Geon | 100 | > | > | > | > | > | > |
| 103EP | | | | | | | |
| TOTM | 20 | > | > | > | > | > | > |
| CaCO₃ | 50 | > | > | > | > | > | > |
| Zinc Borate | 3 | > | > | > | > | > | > |
| ATM | 20 | > | > | > | > | > | > |
| (Hydral 710) | | | | | | | |
| Phosphate | 30 | > | > | > | > | > | > |
| Plasticizers⁽¹⁾ | | | | | | | |
| Brominated FR | 0 | 18.45 | 10 | 16.96 | 16 | 15.1 | 16 |
| Epoxy Soya | 5 | > | > | > | > | > | > |
| Oil (ESO) | | | | | | | |
| Stabilizers | 5 | > | > | > | > | > | > |
| Totals: | 233 | 251.45 | 243 | 249.96 | 249 | 248.1 | 249 |

⁽¹⁾Either Phosflex 390 or Phosflex 31L the results of which are shown respectively in Table 2.
“>” is understood to indicate that the value therein is identical to the value expressed in the same row of the column preceeding.
PVC Geon 103EP is a vinyl suspension resin available from PolyOne (formerly the Geon Corporation)
TOTM is tri-octyl trimellitate plasticizer available from Genovique Specialties Corporation.
Zinc borate is FR/Smoke suppressant additive supplied by Rio Tinto Minerals (U.S. Borax)
ATH is alumina trihydrate (Hydral 710) available from Almatis
Epoxy Soya Oil is Estabex 2307 an epoxidized soybean oil used as an acid scavenger available from Akcros Chemicals

In addition to these additives, a vinyl stabilizer is used to maintain color and/or processing integrity of the composites. All the above formulations contain a mixed metal, barium and zinc soap stabilizer called BZ4975 manufactured by Akcros Chemicals.

These formulations (coating samples) were compounded in the aforementioned process regime and subjectively measured for stability visually through evolved color. Formulations were prepared with a phosphate ester plasticizer, judging formulations in both an ADP (Phosflex 390) or triaryl phosphate (Phosflex 31L). To examine the relative stability of these compounds, the formulations were processed in a Brabender bowl; mixer preset to an aggressive processing regime (180° C./55 rpm) and at prescribe time intervals, small samples were drawn from the molten mixture and pressed into small, disks. These sample disks were visually compared for relative color development and if possible, the composites were tested to their “end point” (complete resin degradation).

The control composite using DP-45 as the bromine FR was one of the most stable composites. The mixture shown minimal color development during the aggressive process cycle. Of the BEOs evaluated, F2016 was shown to be the closest in low color development as visually compared to the composite standards (DP45); the equivalent of the control whereas the other BEOs showed slightly worse (darker) color development under the same process regime.

### Flammability

Limited Oxygen Index is an ASTM test method (D2863) used extensively by persons skilled in the art of flammability measurement. This test measures the minimum concentration of oxygen necessary to sustain combustion. The more flame retardant efficient the composite is, the more oxygen is required to sustain the flame. The values reflected in Table 2 are the minimum percent oxygen environments needed to sustain combustion of each of these composites.

UL94 is another flammability test (sponsored by Underwriters Laboratories) well known in the industry especially for testing plastics and polymers used in electrical devices. Five test bars of 5″×0.5″× 1/16″ dimensions are separately ignited at the bottom of each specimen with a small Bunsen burner for up to two ten second, ignitions (if the specimen self-extinguishes after the first ignition, another ten second ignition is applied to the bottom of the specimen). Depending on the burning characteristics of each of the five specimens the following ratings are assigned:

| Criteria Conditions | UL94/V0 | UL94/V1 | | UL94/V2 | |
|---|---|---|---|---|---|
| Afterflame time for each | ≦10 sec. | ≦30 | sec. | ≦30 | sec. |
| specimen ignition | | | | | |
| Total cumulative afterflame time | ≦50 sec. | ≦250 | sec | ≦250 | sec |
| for five samples | | | | | |
| Afterflame plus afterglow for | ≦30 sec | ≦60 | sec | ≦60 | sec |
| each sample after second | | | | | |
| ignition | | | | | |

| | | | |
|---|---|---|---|
| Afterflame or afterglow up to | No | No | No |
| the specimen holder (~4″) | | | |
| Cotton ignition by flaming drips | No | No | Yes |

The ratings V-0, V-1, V-2 and Failed are given for specific flammability performance. UL94-V-0 rating is awarded to composites which have self-sustaining combustion of less than ten seconds per ignition [with accumulated burn times for the five samples of less than fifty (50) seconds] and is the preferred rating as the material shows a minimum self supporting flame time and does not exhibit flaming drips. V1 is similar to V0 but allows for longer combustion times and V2 allows for flaming drips which ignites finely stretched cotton batting under the test sample.

The UL94 vertical flammability of the above coating samples were measured and reported in Table 2 below;

TABLE 2

| Components | | | | AFT |
|---|---|---|---|---|
| Bromine | Phosphate | LOI | UL94 | (avg. flame time) |
| Source | Plasticizer | 1.6 mm | 1.6 mm | (sec.) |
| DP45 | 390 | 26.5 | V-0 | 1.1 |
| DP45 | 31L | 30.0 | V-0 | 1.2 |
| F2016 | 390 | 27.5 | V-0 | 0.9 |
| F2016 | 31L | 30.0 | V-0 | 0.9 |
| F2400 | 390 | 28.5 | V-0 | 1.1 |
| F2400 | 31L | 31.0 | V-0 | 0.9 |
| F3100 | 390 | 26.5 | V-0 | 0.8 |
| F3100 | 31L | 31.5 | V-0 | 0.6 |

390 = isodecyl diphenyl phosphate ester, which is Phosflex 390 available from ICL Supresta;
31L = isopropylated triphenyl phosphate ester, which is Phosflex 31L, available from ICL Supresta

Although adjusted for equivalent bromine, there was seen an improvement to the LOI when flame retardant BEO compounds were used (Table 2). UL94 measurement remained at advantageous levels. AFT is determined by addition of the cumulative burn times of five samples and dividing by ten (up to two ten second ignitions for each sample).

A third set of coating samples was prepared using another ADP (alkyl diphenyl phosphate) plasticizer, Santicizer 2148 (C₁₂-C₁₄ linear ester of diphenyl phosphate, Ferro Corporation) and flammability was measured by the cone calorimeter flammability (ASTM-1354-90) as shown in Table 3. Each component in Table 3 is expressed in parts by weight of the total weight of the formulation.

TABLE 3
FR-PVC Composites Using Brominated FRs and Santicizer 2148

| | | | | | | | |
|---|---|---|---|---|---|---|---|
| Bromine FR source - | None | DP-45 | DBDPO | 2016 | 2400 | 3020 | 3100 |
| PVC Geon 103EP | 100 | > | > | > | > | > | > |
| TOTM | 20 | > | > | > | > | > | > |
| CaCO3 | 50 | > | > | > | > | > | > |
| Zinc Borate | 3 | > | > | > | > | > | > |
| ATH (Hydral 710) | 20 | > | > | > | > | > | > |
| Santicizer 2148 | 30 | > | > | > | > | > | > |
| Brominated FR | 0 | 18.45 | 10 | 16.96 | 16 | 15.1 | 16 |
| ESO | 5 | > | > | > | > | > | > |
| Stabilizers | 5 | > | > | > | > | > | > |
| Totals: | 233 | 251.45 | 243 | 249.96 | 249 | 248.1 | 249 |
| Cone Heat Flux - 50 kW/m² | | | | | | | |
| Heat evolved (MJ/m²) | 224.4 | 38.2 | 40.2 | 40.7 | 35.7 | 36.5 | 34.4 |
| | 43.6 | 41.5 | 41.7 | 38.3 | 36.1 | 35.1 | 38.1 |
| Average | 134 | 39.85 | 40.95 | 39.5 | 35.9 | 35.8 | 36.25 |
| Smoke Released (1/s) | 7067.2 | 1336.111 | 1732.9 | 1502.4 | 1420.6 | 1296.2 | 1552.3 |
| | 1326.5 | 1593.9 | 1722.3 | 1374.9 | 1416.9 | 1361.3 | 1558.6 |
| Average | 4196.85 | 1465.005 | 1727.6 | 1438.65 | 1418.75 | 1328.75 | 1555.45 |
| Avg. HRR (kW/m²) | 1364.76 | 233.71 | 243.31 | 253.82 | 215.71 | 221.53 | 210.79 |
| | 265.59 | 247.92 | 253.21 | 233.42 | 219.40 | 212.67 | 232.87 |
| Average | 815.175 | 240.815 | 248.26 | 243.62 | 217.555 | 217.1 | 221.83 |

HRR—heat release rate

The method of determining smoke suppression below is is recognized in the ASTM-1354-90 cone calorimeter fire test.

### Smoke Suppression

The information shown in table 3 also discusses the low smoke efficiency of these formulations. Relative to the control (no bromine FR), the amount of smoke evolved is significantly less and in several cases are similar in low smoke generation as with the control composites using either DP45 or decabromodiphenyl oxide. By cone calorimeter smoke analysis (smoke density measured by single point laser probe of combustion gases collected in the plenum of the cone apparatus) the rate of smoke generated is similar to the two controls chosen.

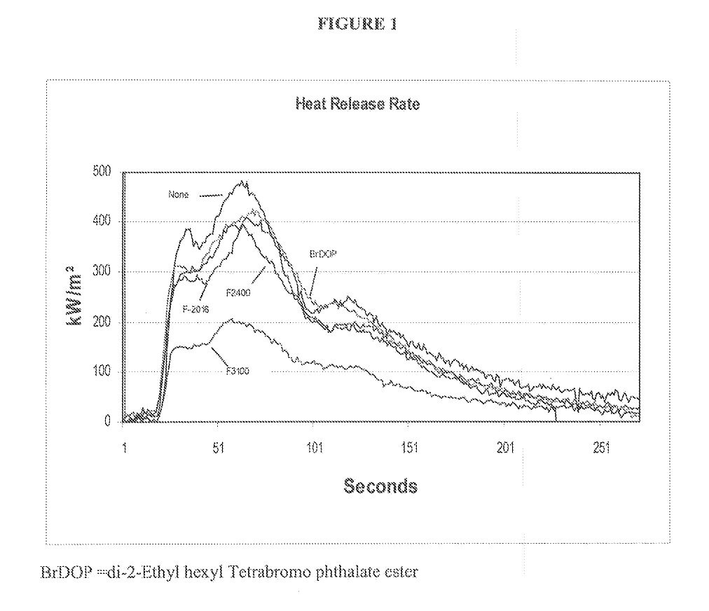

The heat release rate is a measure of the intensify of the fire due to volatile mass loss during combustion and the fuel energy of these volatile gases. In FIG. 1, the flame retardant efficiency of the vinyl composite containing BEO's are in general more flame retardant efficient that the control DP-45. Of note is the flame retardant performance of F3100 as the BEO bromine source; clearly is more effective in reducing the intensity of the combustion. The values plotted in FIG. 1 are obtained from Table 3. DP45 is BrDOP (brominated dioctyl phthalate).

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

1. A wire and/or cable comprising (a) a conductor and (b) a covering comprising:
(i) a brominated epoxy oligomer; and,
(ii) a phosphate ester.

2. The wire or cable of claim 1 wherein the brominated epoxy oligomer (i) is selected from the group consisting of the general structures (I) and (II) 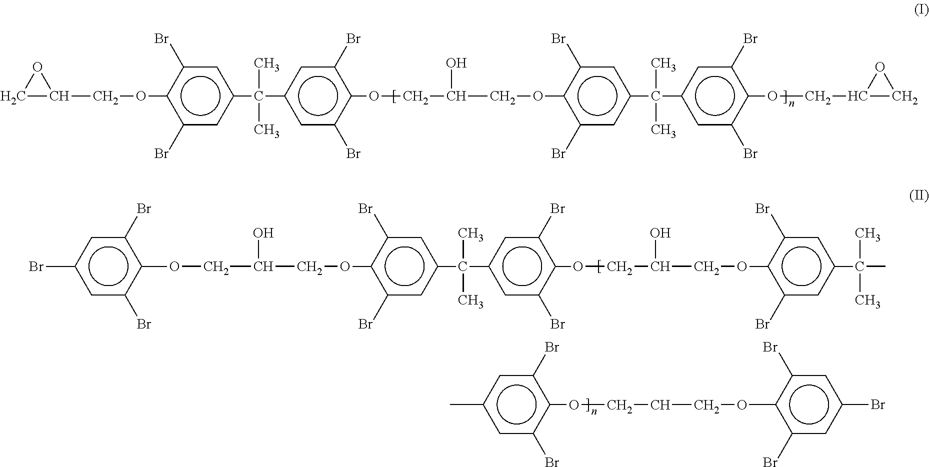
wherein n is 0 or from 1 to about 10.

3. The wire and/or cable of claim 1 wherein the brominated epoxy oligomer (i) contains at least one repeat unit of the general formula: 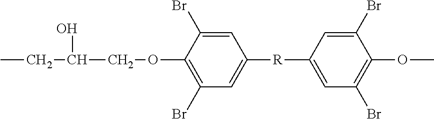
where R is a divalent alkylene group containing from 1 to about 6 carbon atoms.

4. The wire and/or cable of claim 1 wherein the phosphate ester (ii) is a monomeric phosphate ester or an oligomeric phosphate ester.

5. The wire and/or cable of claim 1 wherein the phosphate ester (ii) is of the formula O═P—(OR¹)₃ wherein R¹ is independently selected from alkyl, alkoxyalkyl and haloalkyl containing up to about 8 carbon atoms.

6. The wire and/or cable of claim 1 wherein the phosphate ester (ii) is of the general formula (R²O)ₙP(O)(OR³)₃₋ₙ. wherein n is equal to 1 or 2, R² is an alkyl group of from 1 to about 30 carbon atoms, and R³ is an aryl group having up to about 14 carbon atoms.

7. The wire and/or cable of claim 1 wherein the phosphate ester (ii) is selected from the group consisting of diethyl phenyl phosphate, ethyl diphenyl phosphate, di-n-propyl phenyl phosphate, n-propyl diphenyl phosphate, di-n-butyl phenyl phosphate, n-butyl diphenyl phosphate, di-isobutyl phenyl phosphate, isobutyl diphenyl phosphate, di-n-pentyl phenyl phosphate, n-pentyl diphenyl phosphate, di-n-hexyl phenyl phosphate, n-hexyl diphenyl phosphate, and mixtures thereof.

8. The wire and/or cable of claim 1 wherein the phosphate ester (ii) is a phosphate ester oligomer having a phosphorus content of not less than about 5% by weight.

9. The wire and/or cable of claim 1 wherein the phosphate ester (ii) is of the general formula 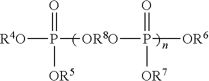
wherein n is 0 or 1 to about 10, R⁴, R⁵, R⁶ and R⁷ each independently is a non-halogenated or halogenated alkyl or aryl group containing up to about 30 carbon atoms, and R⁸ is a non-halogenated or halogenated alkylene or arylene group, provided, that at least one of R⁴, R⁵, R⁶, R⁷ and R⁸ is aryl of 6-20 carbon atoms, and, provided when n is 0, then at least one of R⁴, R⁵, R⁶ and R⁷ is aryl of 6-20 carbon atoms.

10. The wire and/or cable of claim 1 wherein the phosphate ester (ii) is selected from the group consisting of butylated aryl phosphate, a propylated aryl phosphate, or a methylated aryl phosphate.
